(19) United States
(12) Patent Application Publication
(10) Pub. No.: US 2004/0261477 A1
(43) Pub. Date: Dec. 30, 2004

(54) Combination lock

(76) Inventor: Song-Ming Wang, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/601,570

(22) Filed: Jun. 24, 2003

(51) Int. Cl. E05B 13/00

(52) U.S. Cl. 70/214; 70/313

(57) ABSTRACT

A combination lock is provided, each of buttons of which has to be pressed respective correct numbers of times (including zero time) for unlocking the lock, therefore there is wider variety of different unlocking combinations with limited numbers of buttons, preventing unauthorized persons from easily guessing the current unlocking combination. The combination lock is made such that a knob connected thereto will be, when operated, only capable of turning in an idle manner without causing a dead bolt to disengage a door equipped with the lock unless all numbered buttons of the lock are correctly pressed according to the current unlocking combination, preventing unauthorized persons from succeeding in unlocking the door by means of turning the knob violently.

### BACKGROUND OF THE INVENTION

1. Field of the Invention

The present invention relates to a combination lock, more particularly one, which is used on a door, and comprised of several numbered buttons, each having to be pressed correct numbers of times for unlocking the lock, and which is constructed such that a knob connected thereto will be, when operated, only capable of turning in an idle manner without causing a dead bolt to retreat to the disengaged position unless all of the numbered buttons are respectively pressed correct number of times to make the lock unlock.

2. Brief Description of the Prior Art

The importance of locks has never been negated since first locks were made available, and many different locks have been made over time, each having a particular usage and function, e.g. gear shift locks, steering wheel locks, steel rope locks, mortise locks, and combination locks. There are more and more large buildings equipped with combinations locks, by means of which the management of the buildings can be sure that only authorized persons have access to the buildings.

A type of conventional lock is made to have several numbered buttons fitted thereon, and correct ones of the numbered buttons have to be pressed for unlocking the lock. In other words, each of the numbered buttons is either in pressed position or not-pressed position when the buttons are operated according to the unlocking combination to unlock the lock. For a combination lock of such type that has ten numbered buttons, and that can be unlocked by means of pressing four correct ones of the buttons, the chance of successful unlocking is one in one hundred and forty

$${c}_{4}^{10} = \frac{10 !}{4 ! ( 10 - 4 ) !}$$

in one try to unlock the lock, wherein four randomly chosen ones of the buttons are pressed. Therefore, there is not a wide enough variety of different unlocking combinations for a lock of the above type that is equipped with few buttons, e.g. fewer than ten, to prevent unauthorized persons from easily guessing the current unlocking combination.

Furthermore, conventional combination locks are made in such a manner that when they are used together with a knob on a door, and when numbered buttons thereof are not correctly pressed according to the unlocking combination, internal stopping parts of the locks will stay engaged with the knob to prevent the knob from turning, thus preventing a dead bolt from disengaging the door. Consequently, a thief will be able to force the lock to unlock by means of turning the knob violently to disengage the dead bolt from the door.

### SUMMARY OF THE INVENTION

It is a main object of the present invention to provide a combination lock, which is made in such a manner that there is a wider variety of different unlocking combinations provided to it than conventional combination locks with same numbers of buttons, thus preventing a thief from easily guessing the current unlocking combination; the combination lock is comprised of several numbered buttons, each of which has to be pressed respective correct numbers of times (including zero time) for unlocking the lock.

It is another object of the present invention to provide a combination lock, which is made such that a knob connected thereto will be, when operated, only capable of turning in an idle manner without causing a dead bolt to disengage the door unless all numbered buttons of the lock are correctly pressed according to the current unlocking combination. In other words, the knob will be engaged with the dead bolt to be operable to disengage the dead bolt from the door only when the combination lock is unlocked, preventing a thief from succeeding in forcing the lock to unlock by means of turning the knob violently.

### BRIEF DESCRIPTION OF THE DRAWINGS

The present invention will be better understood by referring to the accompanying drawings, wherein:

FIG. 1 is an exploded perspective view of the combination lock according to the present invention,

FIG. 2 is a first partial exploded perspective view of the combination lock according to the present invention,

FIG. 3 is a second partial exploded perspective view of the combination lock according to the present invention,

FIG. 4 is a view showing installing of the combination lock to a door according to the present invention,

FIG. 5 is a first vertical cross-sectional view of the combination lock according to the present invention,

FIG. 6 is a partial view of the combination lock of the present invention,

FIG. 7 is a first front view of the combination lock according to the present invention,

FIG. 8 is a second front view of the combination lock according to the present invention,

FIG. 9 is a top view of the combination lock of the present invention,

FIG. 10 is a partial side view of the combination lock of the present invention with numbered buttons in depressed position,

FIG. 11 is a view of the ringed lock plates of the combination lock of the present invention under setting of unlocking combination,

FIG. 12 is a view showing operation of the unlocking combination setting knob of the combination lock of the present invention,

FIG. 13 is view showing the position of the ringed lock plates after the unlocking combination has been set,

FIG. 14 is a view showing operation of the confirmation button of the combination lock of the present invention,

FIG. 15 is a partial view of the combination lock of the present invention when the knob connected to a door is being operated,

FIG. 16 is a section of the combination lock of the present invention after the knob connected to the door has been operated, and

FIG. 17 is a section of the combination lock of the present invention when the clear button is being depressed.

### DETAILED DESCRIPTION OF THE PREFERRED EMBODIMENTS

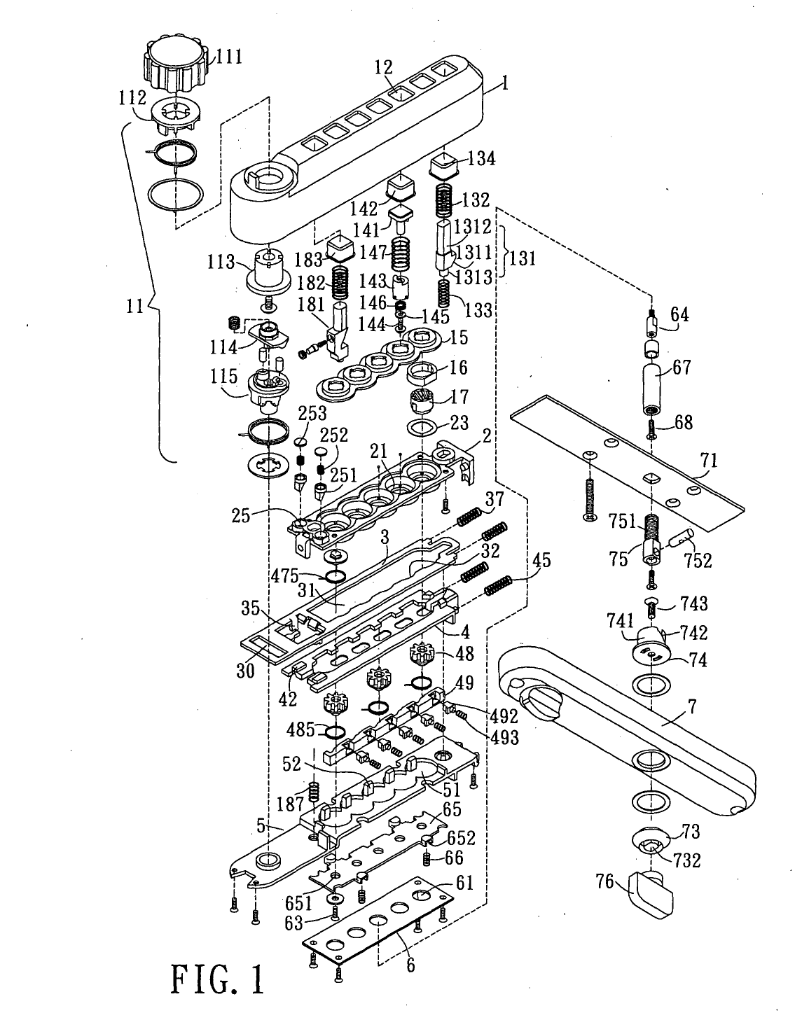

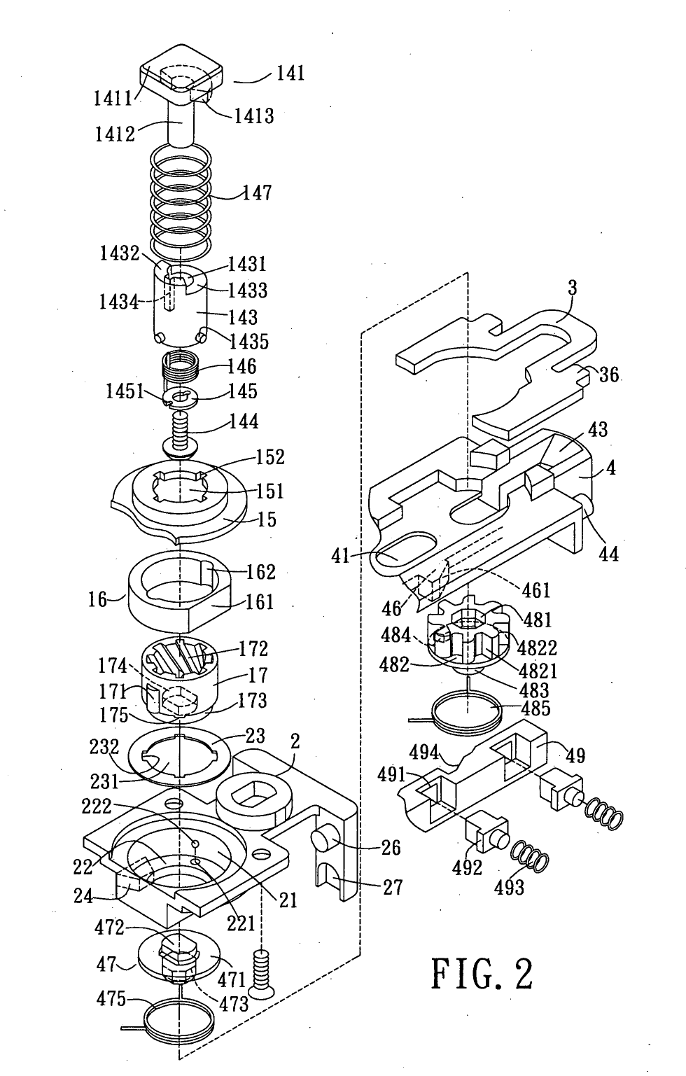

Referring to FIGS. 1, and 2, a preferred embodiment of a combination lock in the present invention includes an outward housing part 1, an inner base 2, a push plate 3, a main recover base 4, a bottom base 5, a bottom cover 6, and an inward housing part 7, and is to be fitted to a door 8 for use:

the outward housing part 1 has a knob mechanism 11 fitted thereto, which is provided for retreating a dead bolt 81 to a disengaged position so that the door is unlocked; the outward housing part 1 has several button holes 12 formed thereon for buttons to be fitted thereto, which buttons includes one clear button 13, one confirmation button 18, and numbered buttons 14;

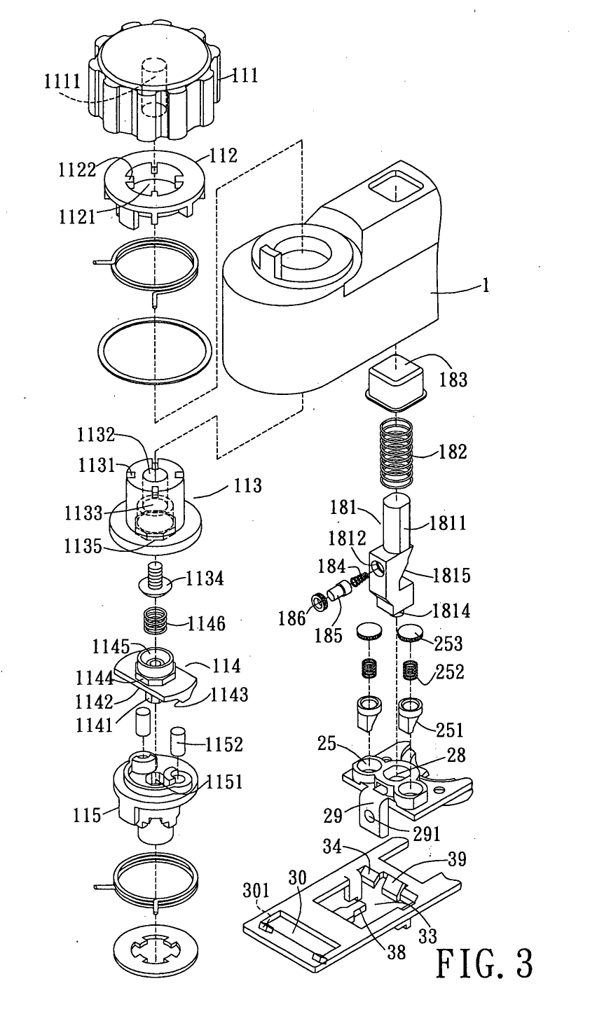

referring to FIG. 3, the knob mechanism 11 includes a knob 111, an inner member 112, a fixing base 113, a rotary gear 114, and a push base 115; the knob 111 has a hollow post 1111 formed with threads on an inner side thereof; the inner member 112 has a middle hole 1121, and several engaging protrusions 1122 around the middle hole 1121 on an inner annular side; the inner member 112 is arranged in the knob 111 with the threaded hollow post 1111 passing through the middle hole 1121; the fixing base 113 has engaging holes 1131 on the edge of an upper end, a middle through hole 1132, a holding hole 1133 under and in communication with the middle through hole 1132, and a polygonal engaging hole 1135 under the holding hole 1133; the fixing base 113 is joined to the knob 111 with the threaded hollow post 1111 passing through the middle through hole 1132 thereof, with the engaging protrusions 1122 of the inner member 112 fitting in corresponding engaging holes 1131, with a bolt or screw 1134 being disposed in the holding hole 1133, and screwed into the threaded hollow post 1111; the rotary gear 114 has a polygonal connecting portion 1141 at a lower end, a plate portion 1142 adjacent to the polygonal connecting portion 1141, slopes 1143 on the lower side of the plate portion 1142, a polygonal engaging portion 1444 on the upper side of the plate portion 1142, a cylindrical portion 1145 on top of the polygonal engaging portion 1444, and a spring 1146 disposed in the cylindrical portion 1145; the push base 115 has a polygonal connecting cavity 1151 on a middle of an upper side thereof, two push posts 1152 nearer to the edge; the push base 115 is joined to the rotary gear 114 with the polygonal connecting portion 1141 fitting into the polygonal connecting cavity 1151 thereof, and with the push posts 1152 being capable of pushing the push plate 3;

the confirmation button 18 consists of an actuating rod 181, and a cap 183; the actuating rod 181 has a holding post 1811 at an upper end portion, which is passed through a spring 182, and the cap 183; the actuating rod 181 has a containing hole 1812 on a first side, in which a spring 184, an engaging pin 185, and a detaining ring 186 are fitted so that the engaging pin 185 is biased outwardly of the containing hole 1812; a holding post 1814 is formed at the bottom of the actuating rod 181, which is passed through a spring 187; the actuating rod 181 further has a slope 1815 formed at an opposite side of the first side to be faced with the pushing slope plate 39 of the push plate 3;

the clear button 13 consists of a lower push post 131, and a cap 134; the push post 131 is formed with a slope 1311, and is passed through springs 132, and 133 at upper and lower portions 1312, and 1313 thereof respectively while the cap 134 is mounted on top of the push post 131;

referring to FIG. 2, each numbered button 14 consists of a cap 142, a rotary shaft 143, and an upper piston 141, which has a top flat portion 1411, a lower hollow rod 1412, and a curved bar 1413 adjacent to the lower hollow rod 1412; the cap 142 is fitted on the top flat portion 1411; the lower hollow rod 1412 is formed with screw threads on an inner side; the rotary shaft 143 has a hole 1431, a curved protrusion 1432 on the upper end, a recess 1433 opposite the curved protrusion 1432 on the upper end, and several protrusions 1435 on an outward side; a torsion spring 146 is held in the hole 1431 with one end thereof being secured to an engaging trench 1434 in the rotary shaft 143; the upper piston 141 is passed into the hole 1431 at the lower hollow rod 1412 thereof with the curved bar 1413 being held in the recess 1433 while a bolt 144 is passed through a fixing plate 145, a lower end of the hole 1431, and the torsion spring 146, and then screwed into the lower hollow rod 1412; the other end of the torsion spring 146 is engaged with a gap 1451 formed on the edge of the fixing plate 145; the rotary shaft 143 is passed through a spring 147 so that the shaft 143, and the upper piston 141 connected to the shaft 143 are biased upwards by the spring 147;

a lock plate cover 15 is disposed, according to FIG. 1, under the springs 147, which is formed with through holes 151 for corresponding numbered buttons 14 to pass through, and gaps 152 adjacent to each through hole 151; the gaps 152 are provided for fitting with the protrusions 1435 of the rotary shaft 143; ringed lock plates 16, each of which has a flat portion 161 on an outward side as well as several trenches 162, are arranged under respective through holes 151 of the lock plate cover 15; rotary bases 17 are arranged in respective ringed lock plates 16 with outward bumps 171 thereof fitting in the trenches 162 so that they can turn together with the ringed lock plates 16; each rotary base 17 is formed with several equidistantly spaced guide trenches 172, each of which slopes at an upper portion, and is vertical at a lower end portion; each rotary base 17 is formed with a lower section 173 smaller than an upper section so that the lower section 173 is in the shape of a step; the step-shaped lower section 173 is formed with an engaging hole 174, of which the edge is substantially similar to a track; each rotary base 17 is further formed with equidistantly spaced protrusions 175 on the bottom of the upper bigger section thereof;

the inner base 2 is formed with several holding rooms 21 thereon, corresponding to the numbered buttons 14 for holding respective ringed lock plates 16 and respective rotary bases 17 therein; the inner base 2 is formed with an annular platform 22 in each holding room 21, and several equidistantly spaced cavities 221 on each platform 22; beads 222 are positioned on the cavities 221; slide plates 23 are positioned over respective platforms 22; each slide plate 23 has a middle hole 231, and gaps 232 adjacent to the middle hole 231, into which protrusions 175 of the rotary bases 17 are fitted; hollows are formed on upper side of the inner base so that lateral sides of the ringed lock plates 16 are allowed to show; stopping protrusions 24 are formed next to lower ends of the holding rooms 21; the inner base 2 has two holding holes 25 at a first end, in which lock pins 251, and springs 252 are fitted, and over which covers 253 are disposed to prevent the lock pins 251 and springs 252 from falling out; each lock pin 251 has a slope 2511; a through hole 28 are formed between the holding holes 25, through which the actuating rod 181 is passed; the inner base 2 has a downwards extended plate 29 at the first end, which is formed with a through hole 291; the inner base 2 further has down extended walls at the other end, each of which has a connecting post 26 and a recess 27 formed thereon; springs 37 are passed around respective connecting posts 26 at one end while springs 45 are fitted onto respective recesses 27 at one end;

the push plate 3 is formed with a middle hole 31, a corrugated portion adjacent to the middle hole 31 on an inward side thereof, an opening 33, a pushing protrusion 38 in the opening 33, two sloping protrusions 34 formed at opposite direction of the pushing protrusion 38; the sloping protrusions 34 face respective slopes 2511 of the lock pins 251; a pushing slope plate 39 is formed between the sloping protrusions 34, and two downwards extending pushing plates 35 are formed at two inward sides of the push plate 3 that are adjacent to lateral edges of the opening 33; the corrugated portion has several curved recess portions 32, which face respective ones of the ringed lock plates 16; a slot 30 is formed on the push plate 3 next to the opening 33, and two sloping portions 301 are formed on one of those portions of the push plate 3 that are adjacent to the slot 30; the rotary gear 114 are passed through the slot 30 with the slopes 1143 of the plate portion 1142 thereof facing respective ones of the sloping portions 301 of the push plate 3; the push plate 3 further has elongated holding protrusions 36, and the springs 37, which are passed around connecting posts 26 of the inner base 2 at one end, are passed around the elongated holding protrusions 36 at the other end portions;

the main recover base 4 is arranged, also according to FIG. 1, under the push plate 3, and has several elongated holes 41 corresponding to respective numbered buttons 14 in position, two bumps 42 on an upper side of a first end for propping respective lock pins 251 with, and two positioning posts 44 at the other (second) end, which are passed into the other ends of the springs 45 fitted over the recesses 27 of the inner base 2; the main recover base 4 is formed with a slope 43 at the other (second) end, corresponding to the slope 1111 of the clear button 13 in position; several equidistantly spaced push protrusions 46, each which is formed with a slope 461, are formed along a lower side of the main recover base 4; rotary control elements 47 are arranged above respective elongated holes 41; each of the rotary control elements 47 has a flat portion 471, and a polygonal engaging portion 472 on top of the flat portion 471 and fitting into corresponding engaging holes 174 of the rotary bases 17; each rotary control element 47 has a polygonal engaging projection 473 on the bottom of the flat portion 471, a stopping protrusion 474 beside the polygonal engaging projection 473, and a torsion spring 475 fitted thereto, which engages corresponding stopping protrusions 24, and 474 at two ends; rotary locating shafts 48 are arranged under the elongated holes 41 of the main recover base 4; each rotary locating shaft 48 has an engaging hole 481 at a middle, into which polygonal engaging projection 473 of a corresponding rotary control element 47 is fitted so that each ringed lock plate 16 and corresponding rotary base 17, rotary control element 47, and rotary locating shaft 48 will move together with each other; each rotary locating shaft 48 is formed with several engaging trenches 482 on an outward side, each of which engaging trenches 482 includes a flat side 4821, and a curved side 4822, such that each rotary locating shaft 48 is prevented from turning back by means of a corresponding locating pin 492 (to be detailed later) after a corresponding numbered button 14 has been pressed one time to make it turn forwards; each rotary locating shaft 48 is formed with a hollow post 483 at a lower end, which has screw threads on an inner side, and has a stopping protrusion 484 near to the threaded hollow post 483, and has a torsion spring 485 fitted under it with the stopping protrusion 484 being arranged between two ends of the spring 485; the elasticity of the springs 485 is greater than that of the springs 475 connected to the rotary control elements 47; a recover base 49 is disposed under the main recover base 4; the recover base 49 has sloping trenches 494 each corresponding to one of the slopes 461 of the push protrusions 46 in position; the recover base 49 has several pairs of hollows and through holes 491, facing the rotary locating shafts 48; there is a locating pin 492 passed through each through hole 491, and a spring 493 joined to each locating pin 492 for biasing the locating pin 492 outwardly of the through hole 491;

the bottom base 5 has several through holes 51, which communicate with each other, for the rotary locating shafts 48 to be passed through; the bottom base 5 has limiting stop posts 52 each next to one of the through holes 51; the posts 52 have curved sides facing corresponding through holes 51;

the bottom cover 6 is arranged under the bottom base 5, and has round holes 61 under corresponding through holes 51 of the bottom base 5; holed fixing plates 62 are positioned over the round holes 61, through which screws 63, and a screw 64 are passed; a spring base 65 is positioned between the bottom cover 6 and the bottom base 5, and is formed with through holes 651 corresponding to the round holes 61 in respect of position; the screws 63, 64 are passed through the holes 651, and then screwed into the threaded hollow post 483 of the rotary locating shafts 48 so that the rotary locating shafts 48 are fixedly connected to the spring base 65; the spring base 65 is formed with holding tunnels 652 on two lateral sides, in which springs 66 are disposed to bias the spring base 65 upwards; an extending tube 67 is provided, which has screw threads 671 on an inner side, and which is positioned around a lower tube portion 641 of the screw 64; the lower tube portion 641 is formed with threads on an inner side, and a bolt 68 is passed into the extending tube 67 and screwed into the tube portion 641;

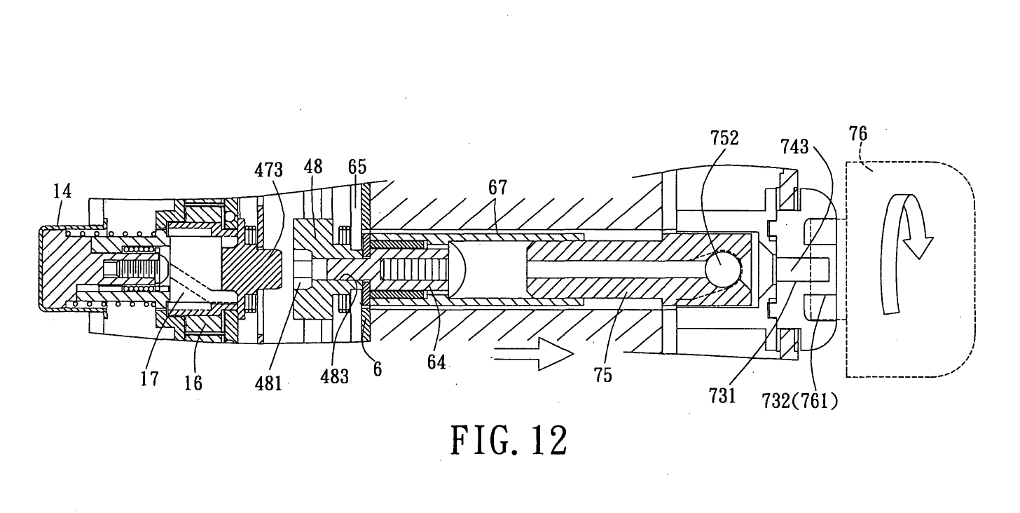

the inward housing part 7 has a subsidiary plate 71 positioned above it, and has a connecting hole 72; an outer base body 73 is fitted on an outer end of the connecting hole 72, which body 73 has a connecting hole 731 on one side, and a polygonal engaging post 732 on the other side; an inner base body 74, and an adjustment rod 75 are arranged between the inward housing part 7 and the subsidiary plate 71; the inner base body 74 has opposing sloping guide trenches 742 on an annular side 741 thereof, and is joined to the outer base body 73 with a screw 743, which is passed through the body 74, and screwed into the connecting hole 731; the adjustment rod 75 has a first threaded end portion 751 screwed to the inner threads 671 of the extending tube 67, a second end portion, and a pull pin 752 transversely passed through and joined to the second end portion; the pull pin 752 is fitted into the sloping guide trenches 742 of the inner base body 74 at two ends; a knob 76 is provided for setting the unlocking combination of the present lock; the knob 76 has a connecting hole 761, into which the polygonal engaging post 732 of the outer base body 73 is fitted, as shown in FIG. 12; thus, movement can be passed on to the rotary locating shafts 48 as well as the spring base 65 via the outer base body 73, the inner base body 74, the adjustment rod 75, the extending tube 67, and the screw 64 to make the same move towards the inward housing part 7 when the knob 76 is turned.

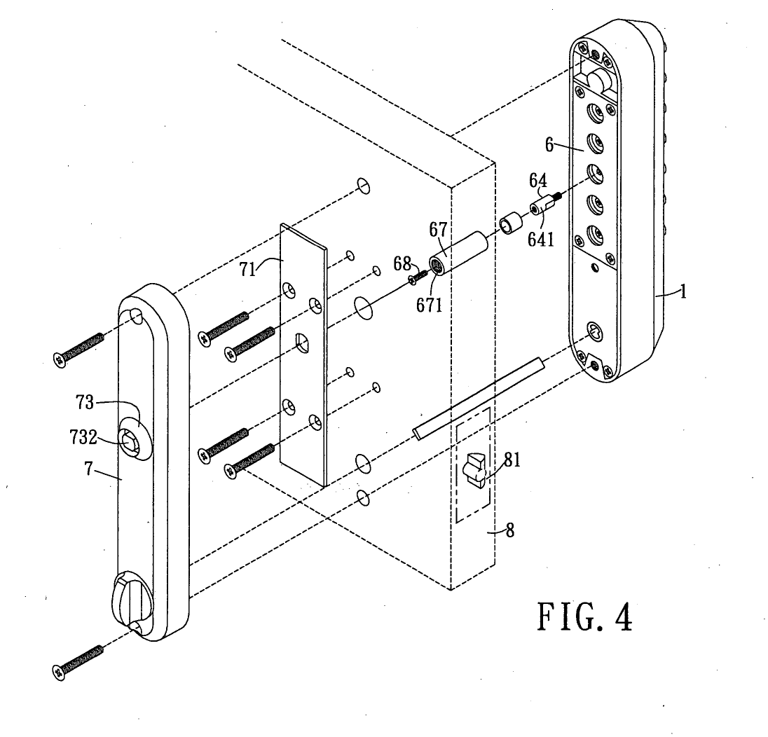

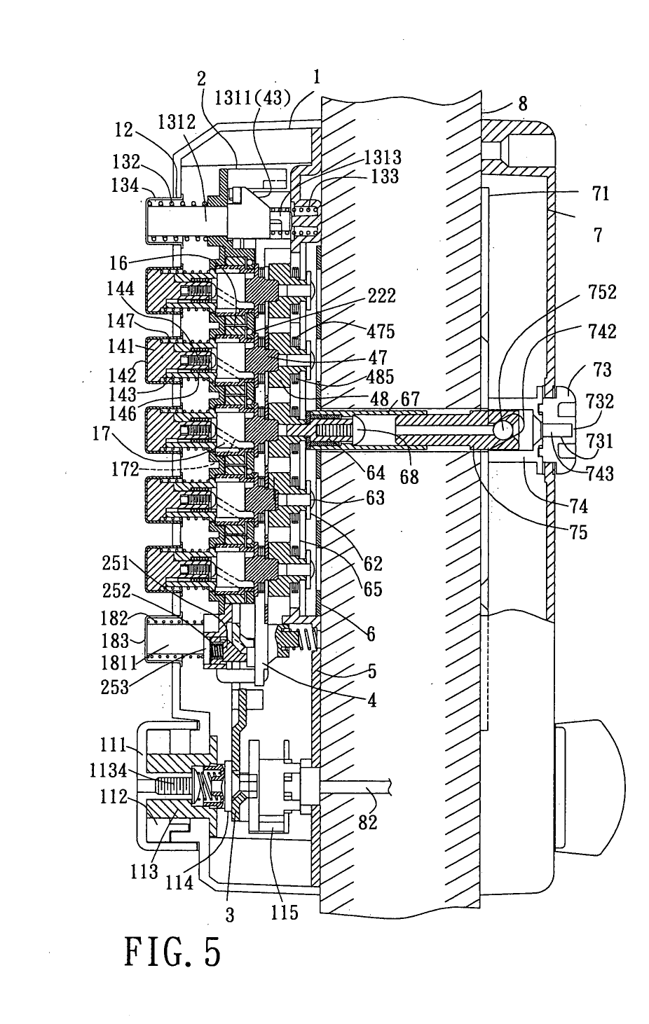

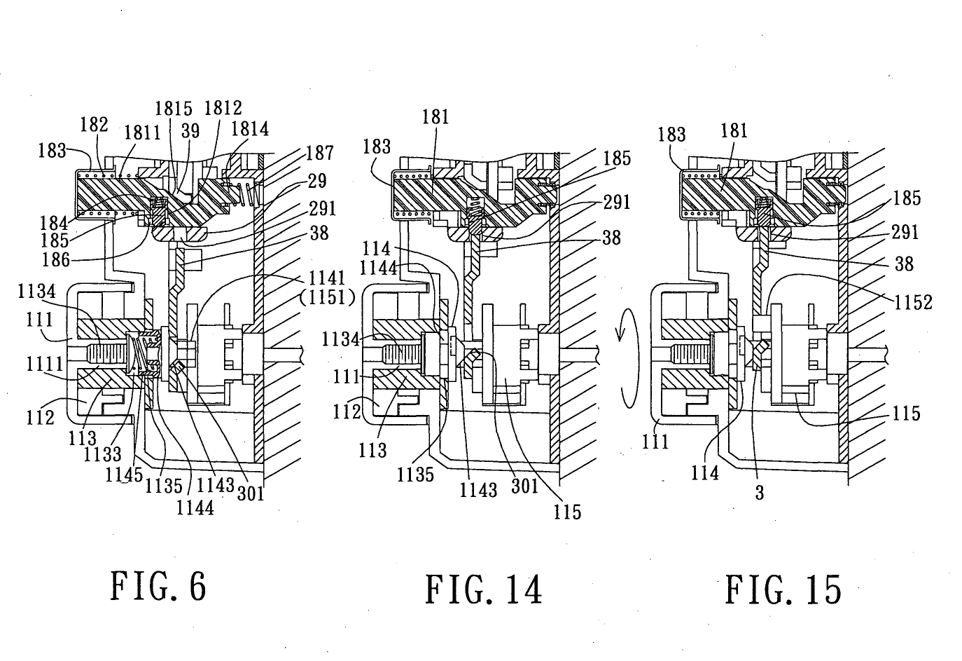

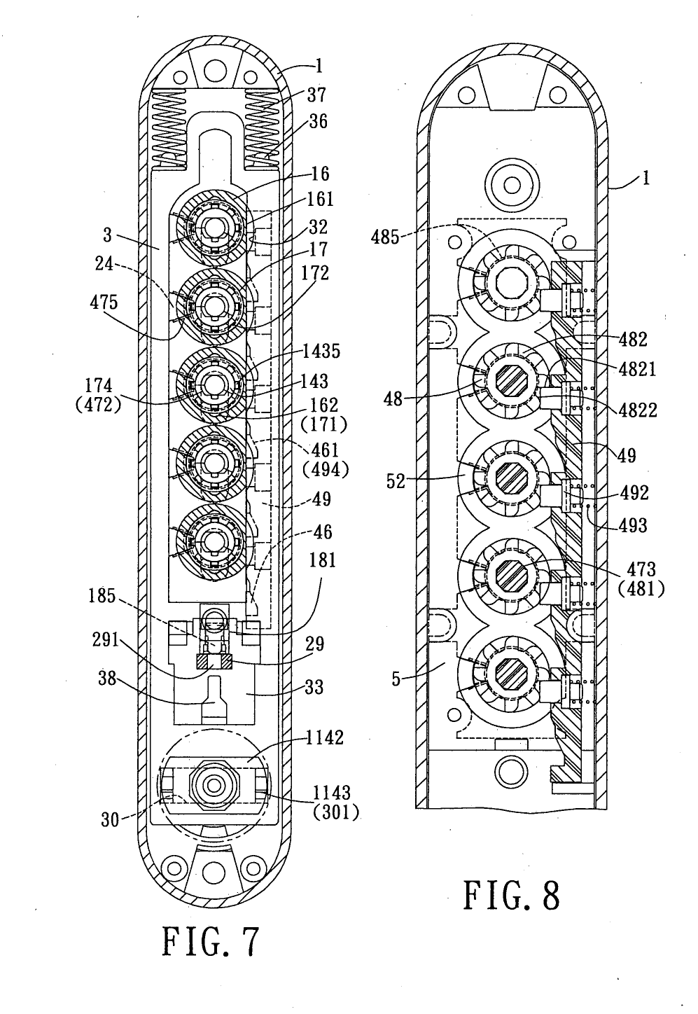

In assembling the lock, referring to FIGS. 4 to 9, the clear button 13, confirmation button 18, numbered buttons 14, lock plate cover 15, ringed lock plates 16, rotary bases 17, inner base 2, push plate 3, main recover base 4, bottom base 5, and bottom cover 6 are joined to the outward housing part 1 as above mentioned, and the outward housing part 1 is secured to an outward side of a door 8 while the inward housing part 7 is arranged on an inward side of the door and fitted to the outward housing part 1.

To unlock the lock, the user has to press each of buttons 14 of the unlocking numeral combination for correct numbers of times. For instance, the unlocking numeral combination is set as 1, 3, 5, and the correct numbers of times, for which the unlocking buttons have to be pressed are 5, 3, 1 respectively, the user has to pressed button 14 denoted with “1” five times, button denoted with “3” three times, and button denoted with “5” one time to unlock the lock. The rotary bases 17 are each formed with eight guide trenches 172, and the rotary locating shafts 48 are each formed with eight engaging trenches 482 in the present embodiment. And, in order for the knob mechanism 11 to be capable of moving the push plate 3 to unlock the door 8, all of the ringed lock plates 16 have to be turned until the flat portions 161 are faced with the curved recess portions 32 of the push plate 3 to not stop the push plate 3 from moving; the knob 111 can also turn to make the dead bolt 81 move together with it for unlocking the door 8.

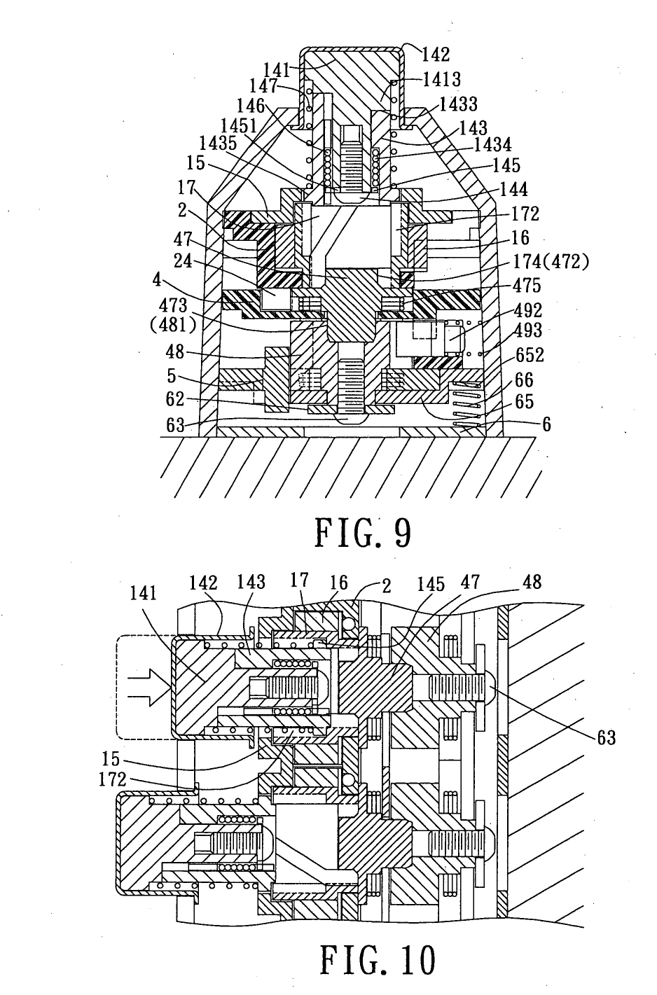

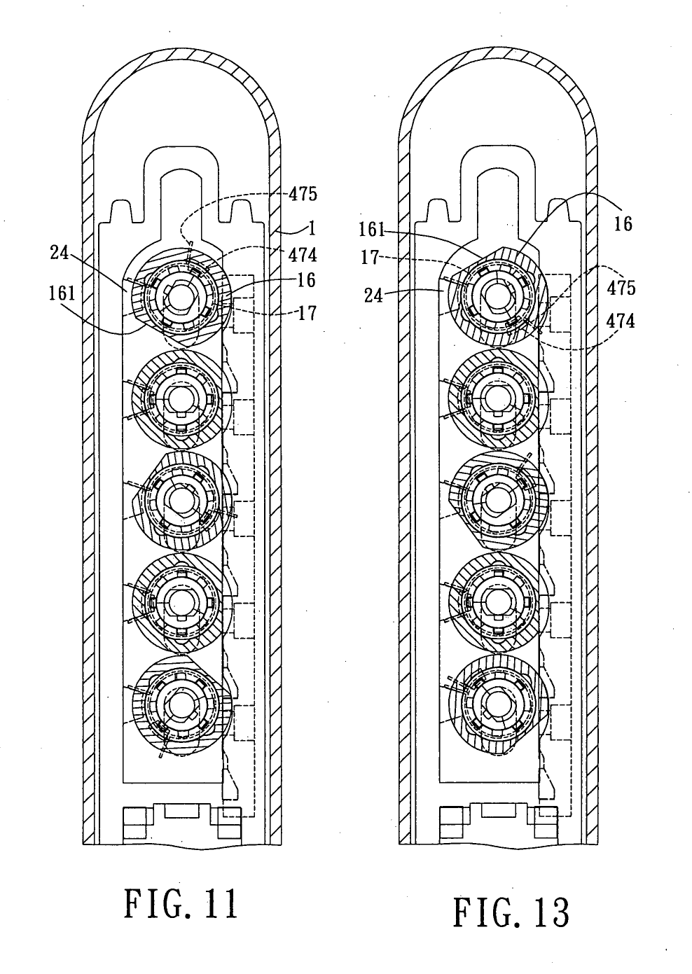

Referring to FIGS. 10, and 11, when the numbered buttons 14 are pressed, the rotary shafts 143 will move down; the rotary basses will rotate at the same time to make the ringed lock plate 16, rotary control elements 47, and rotary locating shafts 48 to turn together with them for a same angle because the protrusions 1435 of the rotary shafts 43 are engaged with the sloping guide trenches 172 of the rotary bases 17, and in turns, the rotary locating shafts 48, rotary control elements 47, ringed lock plates 16, and rotary bases 17 will be held in position after they have been pressed down and turned for above mentioned angle by means of elastic engagement of the locating pins 492 of the recover base 49 with the engaging trenches 482 of the rotary locating shafts 48. When the numbered buttons 14 are released after having been pressed, the upper pistons 141, caps 142, and rotary shafts 143 are forced to move up back to original position by means of the springs 147; the rotary shafts 143 will rotate in a reverse direction on the course of moving back to the original position because the protrusions 1435 thereof will be guided by the guide trenches 172 of the rotary bases 17, and in turns, torsion is stored on the springs 146 until the protrusions 1435 separate from the guide trenches 172, and the springs 146 will make the rotary shafts 143 rotate for certain angle when the protrusions 1435 separate from the sloping guide trenches 172; the above rotation of the rotary shafts 143 is limited by means of the curved bars 1413 of the upper pistons 141 stopping the curved protrusions 1432 of the rotary shafts 143, ensuring that the protrusions 1435 of the rotary shafts 143 easily fit onto the sloping guide trenches 172 when the user again presses the numbered buttons 14 to make the ringed lock plate 16, rotary bases 17, and rotary control elements 47 rotate for certain angle. After buttons 14 denoted with “1”, “3”, and “5” are pressed five times, three times, and one time respectively, flat portions 161 of corresponding ringed lock plates 16 will be away from the corresponding curved recesses 32 of the push plate 3 for five times the mentioned certain angle, three times the mentioned certain angle, and one times the mentioned certain angle respectively, as shown in FIG. 9. Then, referring to FIG. 12, the unlocking combination setting knob 76 is turned to cause the inner and the outer base bodies 74, and 73 to turn together with it; because the adjustment rod 75 cannot turn, the edges of the sloping guide trenches 742 of the inner base body 74 will exert force on two ends of the pull pin 752, and in turns, the adjustment rod 75 moves, and movement of the adjustment rod 75 is passed on to cause the spring base 65 to move via both the extending tube 67 and the spring 64; thus, the rotary locating shafts 48, which are supported with the spring base 65, also move so that the engaging holes 481 of the rotary locating shafts 48 are separated from, and no longer move together with, the polygonal engaging projections 473 of the rotary control elements 47; after the rotary locating shafts 48 are disengaged from the rotary control elements 47, the rotary control elements 47 are made to rotate back to original position by the springs 475, and cause the ringed lock plate 16, and rotary bases 17 to rotate back to original position at the same time. Then, the unlocking combination setting knob 76 is released so that the spring, 66 biases the spring base 65 upwards to original position, and the rotary locating shafts 48 above the spring base 65 also move up, and the engaging holes 481 of the shafts 48 engage the polygonal engaging projections 473 of the rotary control elements 47 again; at the same time, the spring base 65 makes the adjustment rod 75 move up together with it, and in turns, the inner and the outer base bodies 74, 73, and the unlocking combination setting knob 76 are forced to rotate to original position in reverse direction. Then, referring to FIG. 17, the clear button 13 is pressed so that the slope 1311 of the lower push post 131 exert force on the slope 43 of the main recover base 4 to make the main recover base 4 move towards the second end while the equidistantly spaced push protrusions 46 of the main recover base 4 are separating from the sloping trenches 494 of the recover base 49 gradually to cause the recover base 49 to move outwards at the same time; thus, the locating pins 492 are on longer fitted in the engaging trenches 482 of the rotary locating shafts 48, and the rotary locating shafts 48 are released, and turned back to the original position by the springs 485; because the rotary bases 17, rotary control elements 47, and ringed lock plates 16 are associated with the rotary locating shafts 48 in movement, they will continue rotating such that the flat portions 161 of the ringed lock plates 16 associated with the buttons 14 denoted with “1”, “3”, and “5” no longer face the curved recess portions 32 of the push plate 3, and will be away from the corresponding curved recesses 32 of the push plate 3 for five times the mentioned certain angle, three times the mentioned certain angle, and one times the mentioned certain angle respectively. Thus, setting of the unlocking combination is finished as shown in FIG. 13.

The push plate 3 will be still engaged with the ringed lock plates 16 to be incapable of moving, and in turns, the confirmation button 18 can't be pressed down in case all of the numbered buttons of the unlocking combination are not pressed respective correct numbers of times; at the same time, the cylindrical portions 1145 of the rotary gear 114 is still held in the polygonal engaging hole 1135 of the fixing base 113 therefore the knob mechanism 11 fixedly joined to the fixing base 113 can't make the rotary gear 114 move together with it to move the push base 115, only capable of turning in idle manner.

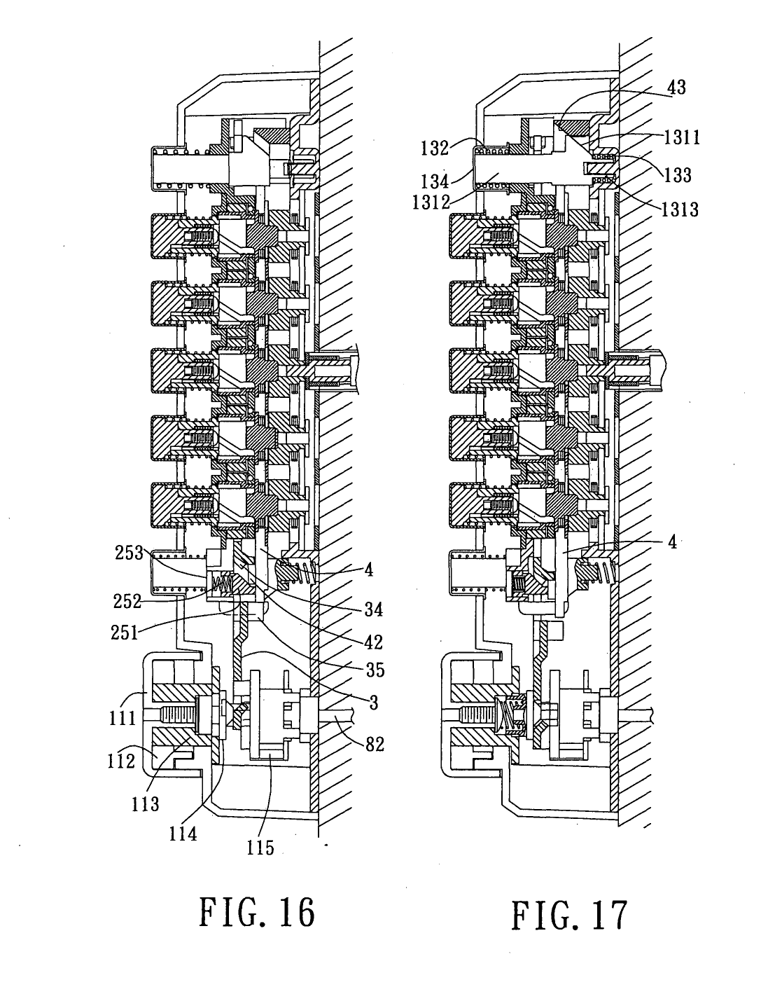

For a person to unlock the door 8 who is outside the room, he first has to press the buttons 14 denoted with “1”, “3”, and “5” five times, three times, and one time respectively; when the buttons 14 are pressed, the protrusions 1435 of the rotary shafts 143 will be fitted into the guide trenches 172 of the rotary bases 17, and work with the sloping sections of the guide trenches 172 to make the rotary bases 17 rotate for a certain angle, and in turns, the ringed lock plates 16, rotary control elements 47, and rotary locating shafts 48 rotate for the same angle together with the rotary bases 17; at the same time, the rotary locating shafts 48, rotary control elements 47, ringed lock plates 16, and rotary bases 17 will be held in position after they have been pressed down and turned for above mentioned angle due to the elastic engagement of the locating pins 492 of the recover base 49 with the engaging trenches 482 of the rotary locating shafts 48. When the buttons 14 are released, the rotary shafts 143 are forced to move up back to the original position by means of the springs 146, and 147, and rotate in a reverse direction on the course of moving back to the original position because of the guide trenches 172 of the rotary bases 17. Because the buttons 14 denoted with “1”, “3”, and “5” are pressed five times, three times, and one time respectively, the corresponding ringed lock plates 16 will rotate for five times the certain angle, three times the certain angle, and one times the certain angle respectively so that flat portions 161 thereof face corresponding curved recess portions 32 of the push plate 3, as shown in FIG. 8, and in turns, the push plate 3 is no longer stopped by the ringed lock plates 16. Then, referring to FIG. 14, the confirmation button 18 is pressed to move the actuating rod 181 downwards so that the slope 1815 of the actuating rod 181 is pressed against the pushing slope plate 39 of the push plate 3 to make the push plate 3 slightly move towards the second end; when the push plate 3 is moved, the sloping portions 301 thereof will be pressed against the slopes 1143 of the rotary gear 114 so that the rotary gear 114 moves upwards, and the polygonal engaging portion 1144 of the gear 114 is engaged with the polygonal engaging hole 1135 of the fixing base 113 for the gear 114 to be capable of moving together with the fixing base 113. Thus, referring to FIG. 16, the rotary gear 114 can be turned to make the push base 115 to move the push plate 3, and make the co-moving plate 82 move the dead bolt 81 for unlocking the door 8 by means of the turning the knob 111. When the confirmation button 18 is pressed to move the actuating rod 181 downwards, the engaging pin 185, which is stopped by the downwards extended plate 29 of the inner base 2, will be directed to, and inserted into, the though hole 291 of the plate 29 so that the actuating rod 181 is fixed in position after the downward movement; referring to FIG. 15, when the knob 111 is turned to make the push base 115 move the push plate 3 towards the second end, the pushing protrusion 38 of the push plate 3 will be passed into the through hole 291 of the inner base 2 to push the engaging pin 185 away from the through hole 29, thus allowing the actuating rod 181 to move back to the original position due to elasticity of the spring 187. Furthermore, the downwards extending pushing plates 35 will make the main recover base 4 towards the second end when the push plate 3 is moved towards the second end by means of the knob 111, and in turns, the push protrusions 46 of the main recover base 4 gradually separate from the sloping trenches 494 of the recover base 49, and at the same time push the recover base 49 outwards to make the locating pin 492 disengage the engaging trenches 482 of the rotary locating shafts 48; thus, the rotary shafts 48 are released, and the springs 485 make the rotary shafts 48 rotate back to the original position; because the rotary locating shafts 48, rotary control elements 47, ringed lock plates 16, and rotary bases 17 can move together with each other, the rotary control elements 47, ringed lock plates 16, and rotary bases 17 associated with the buttons 14 denoted with “1”, “3”, and “5” now rotate in reverse directions for five times the certain angle, three times the certain angle, and one times the certain angle respectively to the original position, and the buttons 14 denoted with “1”, “3”, and “5” have to be respectively pressed five times, three times, and one time for unlocking the door 8 again.

Not all of the flat portions 161 of the ringed lock plates 16 will face the curved recess portions 32 of the push plate 3, and the push plate 3 will be stopped from moving by the ringed lock plates 16 if the buttons 14 are not pressed according to the unlocking combination. Consequently, the door 8 can't be unlocked by means of turning the knob 111. After the buttons 14 have been pressed wrongly, the user first has to press the clear button 13 for allowing the numbered buttons 14 to be operated again to unlock the door 8; referring to FIG. 17, when the clear button 13 is pressed, the slope 1311 of the lower push post 131 will be pressed against the slope 43 of the main recover base 4 to make the main recover base 4 move towards the second end, and in turns, the equidistantly spaced push protrusions 46 of the main recover base 4 cause the recover base 49 to move outwards, and the locating pins 492 are on longer fitted in the engaging trenches 482, i.e. the rotary locating shafts 48 are released; after the locating shafts 48 are released, the rotary control elements 47, ringed lock plates 16, rotary bases 17, and locating shafts 48 are moved back to the original position where the buttons 14 are not pressed.

From the above description, it can be easily understood that although the present lock is equipped with only five numbered buttons, generally fewer than conventional combination locks, it can be set with more different unlocking combinations than a conventional combination lock equipped with more, e.g. ten, buttons because each of the buttons in the unlocking combination has to be pressed correct numbers of times for unlocking. Therefore, the present lock can effectively prevent thieves from finding out the unlocking combination.

Furthermore, the present lock is easy and convenient to use because no other tools are needed to set the unlocking combination.

In addition, the rotary gear 114 is not engaged with the fixing base 113 fixedly joined to the knob 111, and the knob can only be turned in idle manner without actuating the push base 115 and the co-moving plate 83 if the buttons 14 are not pressed according to the unlocking combination. Therefore, a thief cannot force the lock to unlock by means of turning the knob 111 violently.

What is claimed is:

1. A combination lock, comprising
an outer housing part having a knob mechanism, a clear button, and a plurality of numbered buttons fitted thereto; the knob mechanism being provided for pushing a push plate as well as for retreating a dead bolt to a disengaged position so that a door with the lock is unlocked; each numbered button having an upper piston, a first springs, a rotary shaft, a first torsion spring, a fixing plate, a ringed lock plate, a rotary base arranged under a cap thereof; the numbered buttons having a lock plate cover arranged under them; the fixing plate, first torsion spring, rotary shaft, and upper piston associated with each numbed button being joined together by means of a screw; two ends of each first torsion spring being respectively fixedly connected to corresponding rotary shaft, and fixing plate; each ringed lock plate having a flat portion on an outer side; the rotary bases being positioned in, and capable of moving together with, respective ringed lock plates; each rotary base having a plurality of spaced guide trenches on an inner side thereof for allowing protrusions formed on an outer side of rotary shaft of a corresponding numbered button to be fitted onto when the numbered button is pressed; the spaced guide trenches of the rotary bases being formed such that the rotary bases will rotate to make the ringed lock plates rotate together when the protrusions formed on the rotary shafts are moved along them; the clear button having a lower push post arranged under a cap thereof; upper and lower end portions of the lower push post being respectively passed through a second upper spring, and a second lower spring; the lower push post having a slope between the upper and the lower end portions thereof;
an inner base having holding rooms, which oppose corresponding numbered buttons for holding corresponding ringed lock plates and rotary bases therein; hollows being formed on an upper side of the inner base so that parts of the ringed lock plates are allowed to show;
a push plate having an elongated middle hole, curved recess portions spaced along an inner side and next to the elongated middle hole, and downwards extending pushing plates at a first left end; the push plate being connected to third springs at a second right end so as to be biased towards the first end with the third springs;
a main recover base having a plurality of elongated holes formed along it; rotary control elements being arranged above corresponding elongated holes of the main recover base; rotary locating shafts being arranged under corresponding elongated holes; the rotary control elements being joined to, and movable together with, corresponding rotary locating shafts; the main recover base having a slope opposing the slope of the lower push post of the clear button; the rotary control elements being engaged with the rotary bases at upper ends so that each rotary control element, corresponding ringed lock plate, rotary base, and rotary locating shaft can move together with each other; each rotary locating shaft having a plurality of engaging trenches on an annular outer side; fourth springs being connected to a second right end of the main recover base; equidistantly spaced push protrusions being formed along a lower side of the main recover base; a recover base being disposed under the main recover base, and having sloping trenches opposing the push protrusions; the recover base having spring-biased locating pins, which can engage the engaging trenches of corresponding rotary locating shafts; each rotary control element having a fourth torsion spring fitted to a lower end; two ends of each fourth torsion spring being respectively engaged with a corresponding stopping protrusion of the inner base, and a stopping protrusion of a corresponding rotary control element;
a bottom base having a plurality of through holes facing corresponding rotary locating shafts, and a limiting stop post at an edge of each of the through holes thereof; each rotary locating shaft having a fifth torsion spring fitted to a lower end; two ends of each fifth torsion spring being respectively engaged with a corresponding limiting stop post of the bottom base, and a stopping protrusion of a corresponding rotary locating shaft;
a bottom cover having a plurality of round holes facing corresponding rotary locating shafts, and a spring base fitted to an upper side thereof; the spring base being biased up by means of sixth springs; sixth screws being passed through the spring base, and connected to the rotary locating shafts for connecting the rotary locating shafts to the spring base; and
an inward housing part having a knob fitted thereto, which is used for setting a unlocking combination of the lock; the setting knob is connected so as to be capable of moving together with one of the sixth screws for making the spring base and the rotary locating shafts move downwards by means of rotation thereof;
whereby all of numbered buttons in the unlocking combination have to be pressed respective correct numbers of times for successfully unlocking the lock.

2. The combination lock as claimed in claimed 1, wherein each upper piston of numbered button has a curved bar on a bottom thereof while each rotary shaft has a curved protrusion on an upper end, and a recess opposing the curved protrusion; each upper piston being fitted to one of the rotary shafts with the curved bar being received in the recess so that rotation of the rotary shaft is limited within an angle by means of the curved bar; each rotary shaft having an engaging trench therein; each fixing plate having a gap; two ends of each first torsion spring being respectively engaged with a corresponding engaging trench, and a corresponding gap of fixing plate so as to secure the first torsion spring in position.

3. The combination lock as claimed in claimed 1, wherein the lock plate cover has through holes facing corresponding numbered buttons, and gaps adjacent to each through hole thereof for allowing the protrusions formed on the outward sides of the rotary shafts to be fitted in.

4. The combination lock as claimed in claimed 1, wherein each ringed lock plate has a plurality of trenches on an inner side while each rotary base has bumps on an outer side; the bumps being fitted in the trenches of the ringed lock plates so that each rotary base can turn together with a corresponding ringed lock plate.

5. The combination lock as claimed in claimed 1, wherein each of the spaced guide trenches of each rotary base consists of a sloping upper section, and a vertical lower section.

6. The combination lock as claimed in claimed 1, wherein the inner base is formed with a plurality of holding rooms thereon, an annular platform in each holding room thereof, and a plurality of equidistantly spaced cavities on each platform while each rotary base has a slide plate fitted to a lower end thereof, and is passed into one of the holding rooms of the inner base; beads being positioned on the cavities for reducing friction against lower ends of the rotary shafts; each slide plate having a middle hole, and gaps adjacent to the middle hole thereof; protrusions being formed on the rotary bases, and fitted in respective gaps of the slide plates for connecting the slide plates to the rotary shafts.

7. The combination lock as claimed in claimed 1, wherein the second end of the push plate is formed with elongated holding protrusions for the third springs to be passed around; other ends of the third springs being passed around connecting posts formed at a second end of the inner base.

8. The combination lock as claimed in claimed 1, wherein the main recover base has first and second end, and has positioning posts at the second end while the fourth springs are passed around the positioning posts; the inner base having recesses at second end thereof, onto which other ends of the fourth springs are passed.

9. The combination lock as claimed in claimed 1, wherein each rotary base has an engaging hole on a lower side while the each rotary control element has a polygonal engaging portion facing a corresponding engaging hole of the rotary bases on an upper side so that the rotary bases will be capable of rotating together with corresponding rotary control elements after the polygonal engaging portions are fitted into the engaging holes.

10. The combination lock as claimed in claimed 1, wherein each of the engaging trenches of the rotary locating shafts includes a flat side, and a curved side.

11. The combination lock as claimed in claimed 1, wherein the spring base is formed with a plurality of holding tunnels while the sixth springs provided for biasing the spring base up are held in position with the holding tunnels.

12. The combination lock as claimed in claimed 1, wherein one of the sixth screws connecting the rotary locating shafts to the spring base has a tube portion projecting from a lower end thereof; the tube portion having screw threads on an inner side; a bolt being passed through an extending tube, and screwed into the tube portion; the extending tube being connected to the unlocking combination setting knob; the setting knob being connected to an outer base body arranged next to an outer side of the inward housing part; the outer base body being fixedly joined to an inner base body, which is arranged next to an inner side of the inward housing part, and which has sloping guide trenches on an annular side thereof; an adjustment rod being engaged with the sloping guide trenches at two ends of a pull pin thereof; the adjustment being joined to the extending tube so that the spring base can be moved by means of turning the unlocking combination setting knob.

13. A combination lock, comprising
an outer housing part secured to an outer side of a door; the outer housing part having a knob fitted thereto, which is provided for retreating a dead bolt to a disengaged position so that the door is unlocked; the outer housing part having a plurality numbered buttons fitted thereto, which have to be pressed respective numbers of times according to an unlocking combination to unlock the door; the knob being capable of actuating a rotary gear to push a push plate arranged in the outer housing part when the numbered buttons are pressed according to the unlocking combination; and
being characterized by:
the outer housing part having a confirmation button fitted thereto; the confirmation button having an actuating rod, which will be engaged with an inner base to be detained in position after it is moved down by means of pressing the confirmation button; the actuating rod and the push plate having opposing slopes so that the push plate will slide when the actuating rod is moved down; the rotary gear and the push plate having opposing sloping portions so that the rotary gear will move up when the push plate slides; a fixing base being fixedly joined to the knob; the fixing base having an engaging hole on a lower side; the rotary gear having a polygonal engaging portion on an upper side thereof; the polygonal engaging portion being fitted into the engaging hole of the engaging hole of the fixing base so as to make the rotary gear capable of moving together with the fixing base when the rotary gear is moved up;
whereby the knob is only capable of turning in idle manner without causing the rotary gear to turn when the confirmation button is not pressed, failing to make the fixing base, which is fixed to the knob, engage the rotary gear; the rotary gear being moved up to engage the fixing base when the confirmation button is pressed, thus being capable of being turned for unlocking the door by means of turning the knob.

14. The combination lock as claimed in claimed 13, wherein the knob has a downwards projecting hollow post, which is formed with threads on an inner side thereof, and an inner member is positioned within the knob, which has a middle hole, and a plurality of engaging protrusions around the middle hole while the fixing base has engaging holes on an edge of an upper end, a middle through hole, and a holding hole under and in communication with the middle through hole thereof; the threaded hollow post of the knob being passed into the middle through hole of the fixing base; a screw being passed through both the holding hole and the middle through hole of the fixing base, and screwed into the threaded hollow post; the engaging protrusions of the inner member being fitted in corresponding engaging holes of the fixing base.

15. The combination lock as claimed in claimed 13, wherein a push base is engaged with the rotary gear; the push base having two push posts formed nearer to an edge than a middle thereof for pushing the push plate with.
